(19) United States
(12) Patent Application Publication
(10) Pub. No.: US 2002/0024691 A1
(43) Pub. Date: Feb. 28, 2002

(54) Method for detecting abnormality of optical module and apparatus for the same

(75) Inventor: Mikihiro Kajita, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/938,585

(22) Filed: Aug. 27, 2001

(30) Foreign Application Priority Data
Aug. 30, 2000 (JP) 260574/2000

(51) Int. Cl. H04B 10/08; H04B 10/00

(52) U.S. Cl. 359/110; 359/161

(57) ABSTRACT

A value of a current flowing through a specified spot of an optical module is detected by a current detector to be held in a memory. A value of a current is detected again by the current detector a predetermined time later, and a differential value between the detected value of the current and the value of the current held in the memory is obtained by an arithmetic circuit. An alarm circuit generates alarm signal when the differential value exceeds a predetermined threshold value, and calls an attention to a necessity of preventive maintenance. Alternatively, a ratio of the differential value to the past value is further obtained by the arithmetic circuit. The alarm circuit compares the obtained ratio with a predetermined threshold value. If the differential value or the ratio exceeds the predetermined threshold value, the alarm circuit generates the alarm signal.

### BACKGROUND OF THE INVENTION

The present invention relates to preventive maintenance of an optical module for use in an optical fiber transmission system or the like. Particularly, the present invention relates to a method for detecting an abnormality of the optical module and an apparatus for the same.

The optical module is a device for converting electric signals into optical signals, or conversely, converting the optical signals into the electric signals. The optical module is used for, for example, an interface unit for connecting computers with each other through an optical fiber and inputting/outputting signals therethrough at a high speed.

FIG. 12 shows an internal structure of the optical module. For example, when an optical module 10 is of a small form factor (SFF), a transmission system thereof is constituted of a laser diode (LD) or a semiconductor laser 11, a monitor PD 12 and an LD driver (LD drive circuit) 13. Moreover, a receiving system thereof is constituted of a photo-detector (PD) 14 and a PD amplifier 15. Though not shown, pin arrangement, pin assignment and the like are set in accordance with a multi-source agreement of the SFF. A parallel to serial (P/S) converter LSI 16 for converting parallel signals into serial signals and a serial to parallel (S/P) converter LSI 17 for converting the serial signals into the parallel signals are connected with the optical module 10. Thus, parallel data signals from the inside of one computer (not shown) can be serialized to be transmitted to the other computer. Conversely, serial data signals from the other computer can be parallelized to be received by the one computer to which the optical module 10 belongs.

As an example, description will be made below for the case where the optical module 10 is in conformity with Fiber Channel specification. In this case, data signals communicated in 20-bit parallel at 53.125 MHz within one computer are converted through the P/S converter LSI 16 into serial signals of 1.0625 Gbps, and inputted to the optical module 10. The optical module 10 transmits data with the serial signals of 1.0625 Gbps to the other optical module. Similarly, upon receiving the data with the serial signals of 1.0625 Gbps from the other optical module, the optical module 10 sends the data with the serial signals as they are to the S/P converter LSI 17. The S/P converter LSI 17 converts the received serial signals into 20-bit parallel signals at 53.125 MHz, and outputs the converted signals to a computer to which it belongs.

In the inside of the optical module 10, the serial signals (transmission signals) received from the P/S converter LSI 16 are transmitted to the LD driver 13. The LD driver 13 modulates an output of the LD 11 by superposing the serial signals and a DC bias current. In this case, the monitor PD 12 receives a part of an optical output of the LD 11, and returns the same to the LD driver 13 as a monitor current. Based on the monitor current, the LD driver 13 controls a bias current value to the LD 11 by an auto power control (APC) function of the LD driver 13 so that an optical output level of the LD 11 can be fixed. Moreover, serial signals received by the PD 14 are amplified to a size of a logic level by the PD amplifier 15, and outputted to the S/P converter LSI 17.

Meanwhile, in order to realize a highly reliable computer network system, high reliability is required also for the optical module. Therefore, the necessity of the preventive maintenance for the optical module has been increased. Here, the preventive maintenance for the optical module is referred to as a measure to detect an abnormality, which has a high possibility to make the optical module breakdown, of the optical module for preventing occurrence of a breakdown of the optical module beforehand. If the abnormality, which has a high possibility to make the optical module breakdown, is detected, the optical module with the abnormality is replaced for a normal optical module before the abnormality causes the complete breakdown.

One example of technologies applicable to the preventive maintenance for the optical module is described in the gazette of Japanese Patent Laid-Open No. 2000-22631. In the technology of the gazette (hereinafter, referred to as a “prior art”), a bias current of an LD used as a signal light source is regularly compared with a predetermined threshold value. If the bias current of the LD is increased to exceed the threshold value, an alarm to warn an abnormality of the bias current is given. At the same time, the LD driver 13 stops an automatic operation of controlling the optical output at the optical output level of the LD 11 by APC function, and switches to a fixed operation of supplying a drive current of a predetermined value. As a threshold value used here, a bias current value just smaller than a bias current value of an absolute rate as a maximum current value, at which the LD is not broken, is set.

According to the foregoing prior art, when the bias current of the LD 11 exceeds the predetermined threshold value, the alarm to warn the abnormality of the bias current is given, and an excessive increase of the bias current leading to a damage of the LD 11 is suppressed. Therefore, reliability of the optical module is improved. Moreover, if the optical module is replaced for a normal optical module immediately when the alarm is given, it is conceived that the breakdown of the optical module can be prevented beforehand. However, when the prior art is applied to the preventive maintenance for the optical module, there are problems as below.

(1) A work of setting the threshold value for detecting the occurrence of the abnormality, by which a probability of the breakdown is possibly increased, is relatively troublesome. When the bias current value is set as an object to be monitored, in order to perform the preventive maintenance with enough time, it is desirable to set a bias current value larger than a bias current value of the LD in a normal state by a specified value Δ as a threshold value. Here, it is a matter of course that the bias current value set as a threshold value must be equal to the bias current value of the absolute rate or smaller. However, since the bias current value of the LD in the normal state is varied for each LD due to a variation in characteristic of the LD, procedures as below must be taken in order to set the threshold value.

(a) A bias current value of each LD in the normal state is measured.

(b) For each LD, a value which is larger than the measured bias current value by a specified value Δ is calculated.

(c) The calculated value is set as a threshold value for detecting the abnormality of each optical module.

For example, the specified value Δ is set at 20 mA. In this case, when a bias current value of a certain LD(a) in a normal state is 230 mA, a threshold value for detecting an abnormality of the LD(a) is calculated to being 250 mA. Moreover, when a bias current value of another LD(b) in the normal state is 235 mA, a threshold value for detecting an abnormality of the LD(b) is calculated to being 255 mA. As described above, the measurement of the bias current value and the calculation and setting of the threshold value must be performed for each LD. Moreover, since the threshold value is varied for each LD, management must be performed so that the threshold value for another LD cannot be set by mistake.

(2) The optical module must be modified. Specifically, it is difficult to apply the prior art to a commercially available optical module. The reason is that the optical module itself must be modified as described below in order to compare the bias current of the LD with the threshold value to give the alarm since the bias current of the LD is generated in the inside of the optical module.

(a) A circuit for comparing the bias current with the threshold value to give the alarm is built in the optical module itself.

(b) A monitor terminal for taking out the bias current is provided in the optical module, and a circuit for comparing a bias current outputted from the monitor terminal with the threshold value to give the alarm is provided outside the optical module.

(3) An abnormality of a part except for the LD in the optical module cannot be detected. The reason is that the bias current of the LD is an object to be monitored. The present invention was proposed in consideration of the foregoing circumstances. A first object of the present invention is to provide a method for detecting an abnormality of an optical module, which enables to simply set a threshold value for detecting occurrence of an abnormality thereof by which a probability of the breakdown is possibly increased, and an apparatus for the same.

A second object of the present invention is to provide a method for detecting an abnormality of an optical module, which eliminates a necessity of modifying an optical module itself and is applicable to a commercially available optical module itself, and an apparatus for the same.

A third object of the present invention is to provide a method for detecting an abnormality of an optical module, which enables to detect abnormalities of not only a transmission light source such as an LD in the optical module but also other parts due to deterioration over time, and an apparatus for the same.

Other objects, features, advantages and the like of the present invention will be readily apparent to those skilled in the art from the description of embodiments below.

### SUMMARY OF THE INVENTION

A method for detecting an abnormality of an optical module of the present invention includes the steps of: (a) detecting a value of a current flowing through a specified spot of the optical module (for example, a value of a current in a power line for supplying power to the optical module and a value of a current of a transmission light source); (b) storing the detected value of the current in a memory; (c) newly detecting another value of the current flowing through the specified spot at every predetermined time; (d) obtaining a differential value between the value of the current held in the memory and the value of the current newly detected; and (e) generating alarm signal indicating a necessity of preventive maintenance when the obtained differential value exceeds a predetermined threshold value.

Moreover, an apparatus for detecting an abnormality of an optical module of the present invention includes a current detector which detects a value of a current flowing through a specified spot of the optical module, and a memory which holds the value of the current detected by the current detector. Furthermore, the apparatus includes an arithmetic circuit which obtains a differential value between the value of the current held in the memory and a value of a current newly detected by the current detector and an alarm circuit which generates alarm signal indicating a necessity of preventive maintenance when the differential value obtained by the arithmetic circuit exceeds a predetermined threshold value.

The apparatus for detecting an abnormality of the present invention detects the value of the current flowing through the specified spot of the optical module, and compares the differential value, which indicates how much a value of a present current has been changed from a value of a past current, with the threshold value. Alternatively, the apparatus compares a ratio of the differential value to the value of the past current with the threshold value. Thus, occurrence of the alarm signal is controlled. Therefore, even if an equal threshold value is set for the respective objects to be detected, variation in characteristic of each optical module can be absorbed.

### BRIEF DESCRIPTION OF THE DRAWINGS

These and other objects, features and advantages of the invention will become more fully apparent from the following detailed description taken in conjunction with accompanying drawings, in which:

FIG. 1 is a block diagram showing a constitution of a first embodiment of the present invention;

FIG. 2 is a graph showing a change over time in consumption current when a high-temperature life test was actually executed for a large number of optical modules;

FIG. 3 is a flowchart showing a flow of an operation in the first embodiment;

FIG. 4 is a block diagram showing a constitution example of a current detector;

FIG. 5 is a block diagram showing another constitution example of the current detector;

FIG. 6 is a block diagram showing a constitution of a second embodiment of the present invention;

FIG. 7 is a flowchart showing a flow of an operation in the second embodiment;

FIG. 8 is a block diagram showing a constitution of a current detector in the second embodiment;

FIG. 9 is a block diagram showing another constitution of the current detector;

FIG. 10 is a block diagram showing a constitution of a third embodiment of the present invention;

FIG. 11 is a block diagram showing a constitution of a fourth embodiment of the present invention; and

FIG. 12 is a block diagram showing an internal constitution of a conventional optical module.

### DESCRIPTION OF THE PREFERRED EMBODIMENTS

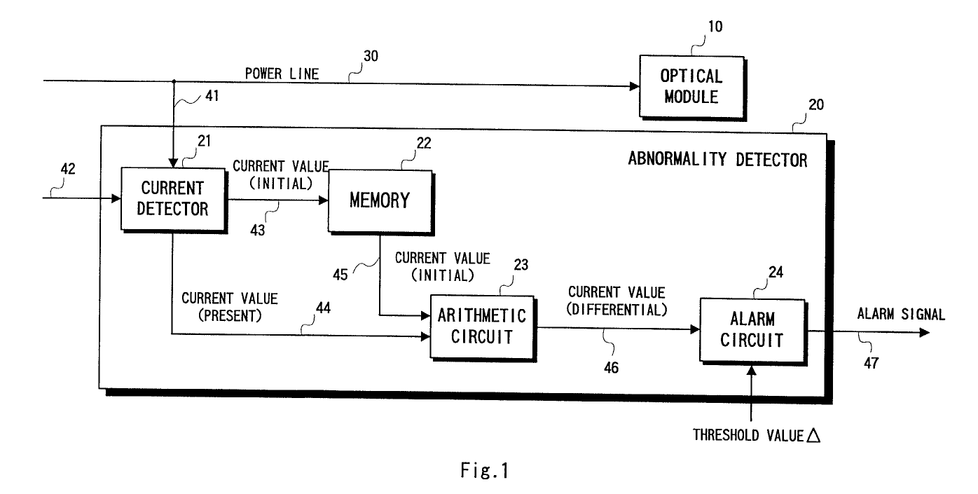

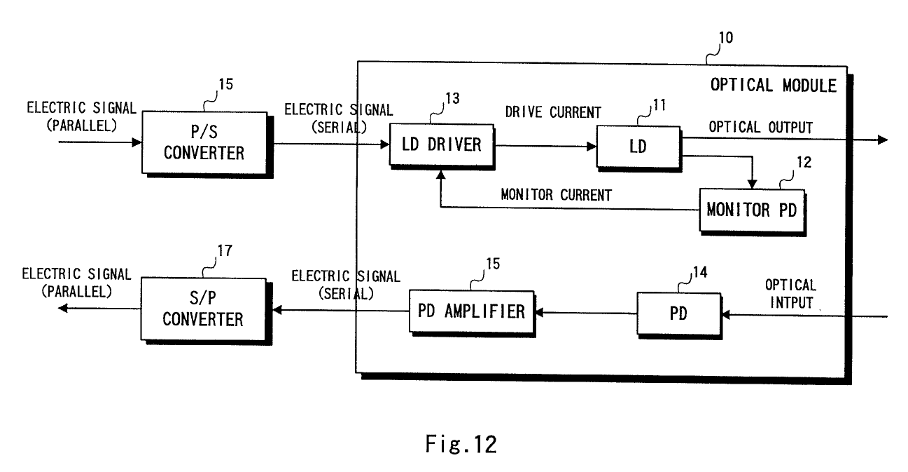

With reference to FIG. 1, an abnormality detector 20 according to a first embodiment of the present invention is an apparatus for detecting an abnormality of an optical module 10 by monitoring a current flowing through a power line 30 for supplying power to the optical module 10. The abnormality detector 20 includes a current detector 21, a memory 22, an arithmetic circuit 23 and an alarm circuit 24 as principal components. The optical module 10 as the object for abnormality detection is not modified at all, and a commercially available optical module itself becomes an object. An internal structure of the optical module 10 is, for example, a structure as shown in FIG. 12. The optical module 10 has an auto power control function for fixing an optical output of an LD based on a monitor current of a light-receiving element which receives the optical output of the LD as monitor light.

The current detector 21 is connected with the power line 30 through a signal line 41, with a computer (not shown) through a signal line 42, with the memory 22 through a signal line 43 and with the arithmetic circuit 23 through a signal line 44. The current detector 21 is activated upon receiving an activation instruction from the computer (not shown) through the signal line 42. The current detector 21 first detects a current value of the power line 30 through the signal line 41, and outputs the current value through the signal line 43 to the memory 22 to be held therein as an initial current value. Thereafter, the current detector 21 iterates an operation of detecting a current value of the power line 30 and outputting the current value through the signal line 44 to the arithmetic circuit 23 as a present current value at every predetermined fixed time T. Here, the fixed time T may be optionally set.

The memory 22 holds the initial current value sent from the current detector 21, and outputs the initial current value to the arithmetic circuit 23 through the signal line 45.

The arithmetic circuit 23 obtains a differential value between the present current value from the current detector 21 and the initial current value from the memory 22, and outputs the obtained differential value through a signal line 46 to the alarm circuit 24.

A threshold value Δ is previously set in the alarm circuit 24. The alarm circuit 24 compares the differential value transmitted from the arithmetic circuit 23 through the signal line 46 with the threshold value Δ. When the differential value exceeds the threshold value Δ, the alarm circuit 24 sends out alarm signals indicating a necessity of preventive maintenance for the optical module 10 to a computer (not shown) through a signal line 47.

Next, description will be made for an operation of this embodiment. In this embodiment, a phenomenon is utilized, in which a consumption current of the optical module 10 tends to increase when an abnormality is caused in a part constituting the optical module 10. For example, when the LD is in a deterioration tendency, the optical output from the LD is lowered. However, when the optical output from the LD is lowered, the LD driver increases a bias current value applied to the LD by the APC function built in the optical module 10 to increase the optical output from the LD, and thus the LD driver attempts to compensate for a lowered amount due to deterioration. When such a deterioration tendency appears, the consumption current in the entire optical module 10 will be increased.

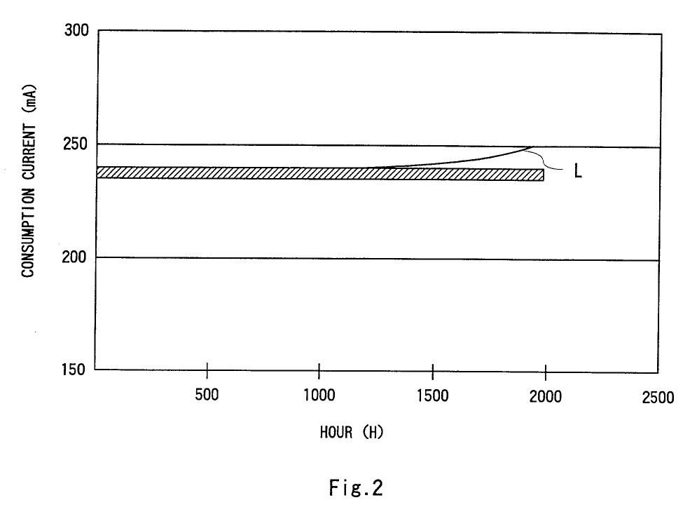

FIG. 2 is a graph showing a change over time in consumption current when a high-temperature life test was actually executed for a large number of optical modules. As shown by a solid line L in the graph, with regard to a part of samples (optical modules), a gradual increase of the consumption current was observed from a point of time when about 1300 hours passed over. The part of samples was not completely broken down at the point of time when the consumption current thereof started to increase. However, after passage of a certain measurement time, they were broken down. A cause of the deterioration in this case was not a breakdown of the LD but a breakdown of the LD driver. From the test results as described above, it was found out that the preventive maintenance was required when the consumption current of the optical module started to increase, and that the deterioration of the parts except for the LD, such as the LD driver, also led to the increase of the consumption current.

Accordingly, in this embodiment, a certain value Δ is set as an increment from the initial consumption current of the optical module, and this value Δ is used as a condition for determining the time when an alarm indicating the necessity of the preventive maintenance should be given. The value Δ is set as a threshold value in the alarm circuit 24.

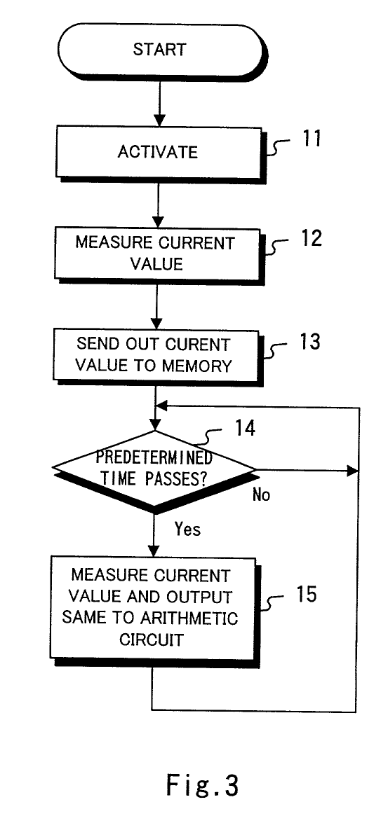

With reference to FIG. 3, at the start time of the actual use of the optical module 10, the current detector 21 is activated by the signals sent from the computer (not shown) through the signal line 42 (S11 in FIG. 3). At the activation, a value of a current supplied from the power line 30 is detected by the current detector 21 (S12) and is held in the memory 22 as an initial current value (S13). Thereafter, at every fixed time T, another current value is detected again by the current detector 21 and is outputted to the arithmetic circuit 23 as a present current value (S14, S15).

The arithmetic circuit 23 obtains a differential value between the newest current value of the power line 30, which is received from the current detector 21, and the initial current value held in the memory 22. The alarm circuit 24 compares the differential value obtained in the arithmetic circuit 23 with the threshold value Δ. If the differential value exceeds the threshold value Δ, the alarm circuit 24 outputs the alarm signal through the signal line 47 to the computer (not shown). Upon receiving the alarm signal, the computer displays, for example, a message to request the replacement of the optical module 10 on a display device or the like. Thus, the preventive maintenance for the optical module 10 can be performed with enough time.

Next, description will be made for a constitution example of each constituent component of the abnormality detector 20.

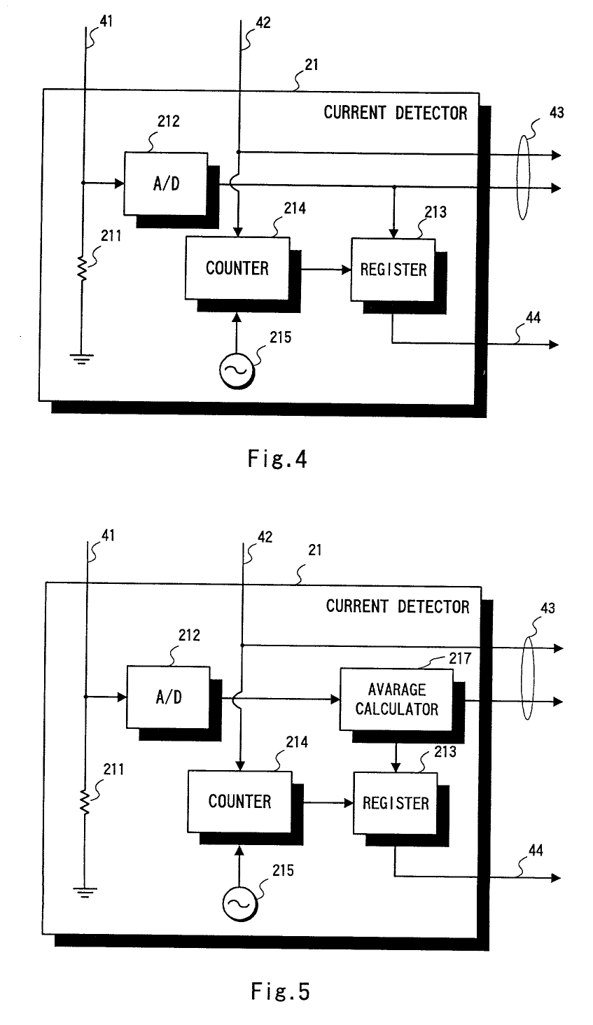

FIG. 4 shows a constitution example of the current detector 21. In the current detector 21, a voltage proportional to the current value of the power line 30 is taken out by a resistor 211 connected with the signal line 41. A value of the voltage is digitized by an A/D converter 212 to be outputted to a register 213 and the computer (not shown) through the signal line 43. Activation signal given from the computer through the signal line 42 is outputted through the signal line 43 to the memory 22 as writing signal thereto, and used as activation signal for a counter 214. The initial current value is held in the memory 22 according to the writing signal. Since the activation signal do not appear in the signal line 42 thereafter, the value in the memory 22 is not changed. When the counter 214 is activated by the activation signal, the counter 214 starts to count output pulses of an oscillator 215. When a count value reaches a value equivalent to the predetermined time T, the counter 214 outputs setting signal to the register 213 and resets the count value to start the count again. The register 213 holds the output of the A/D converter 212 in timing with the setting signal from the counter 214 and outputs the same through the signal line 44 to the arithmetic circuit 23.

In another example of the current detector 21, as shown in FIG. 5, an average calculator 217 is provided just behind the A/D converter 212. In the average calculator 217, an average value of the current values on the power line 30 over the period of the cycle T (about several seconds) is obtained based on the setting signal from the counter 214, and is outputted through the signal line 44 to the arithmetic circuit 23.

The memory 22 constituting the abnormality detector 20 can be constituted of, for example, a register. Moreover, the arithmetic circuit 23 includes a subtracter which subtracts the initial current value through the signal line 45 from the present current value through the signal line 44. Furthermore, the alarm circuit 24 includes a comparator which compares the value of the current received through the signal line 46 with the threshold value Δ and which sets an output (alarm signal) at a logic “1” if the current value exceeds the threshold value Δ.

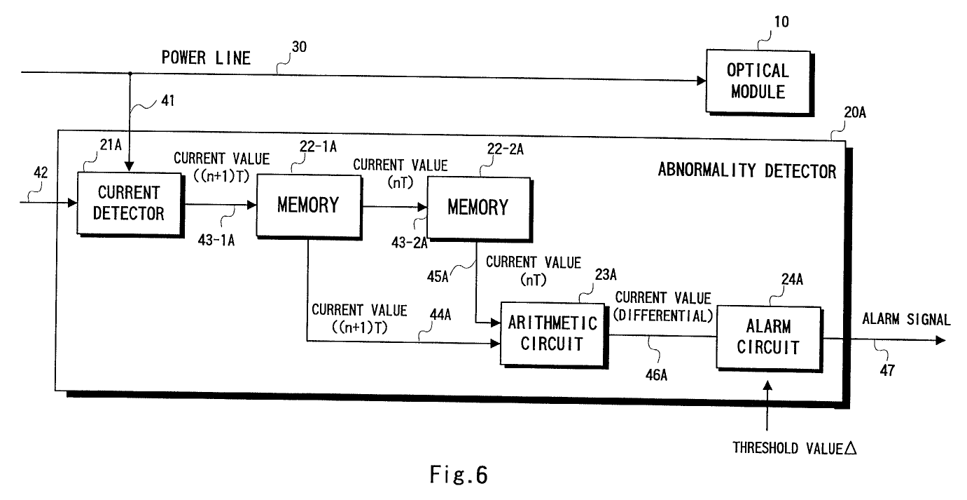

With reference to FIG. 6, description will be made for an abnormality detector 20A according to a second embodiment of the present invention. The abnormality detector 20A detects a current flowing through the power line 30 for supplying power to the optical module 10 as an object for abnormality detection at every fixed time T. The abnormality detector 20A is different from the abnormality detector 20 in the first embodiment in the following point. Specifically, the abnormality detector 20A examines whether or not a differential value between a current value detected this time and a current value detected in the last cycle (at time T before) exceeds a predetermined threshold value, thus detecting an abnormality of the optical module 10.

The abnormality detector 20A includes a current detector 21A, two memories 22-1A and 22-2A, an arithmetic circuit 23A and an alarm circuit 24A. The optical module 10 as the object for abnormality detection is not modified at all similarly to that described in the first embodiment and a commercially available optical module having an APC function can be used.

The current detector 21A is connected with the power line 30 through the signal line 41, with the computer (not shown) through the signal line 42 and with the memory 22-1A through a signal line 43-1A.

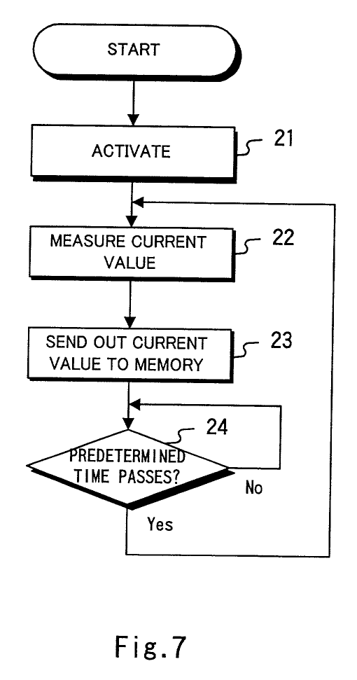

With reference to FIG. 7, the current detector 21A is activated upon receiving an activation request from the computer (not shown) through the signal line 42 (S21). The current detector 21A first detects a current value of the power line 30 through the signal line 41 (S22). Then, the current detector 21A sends the detected current value through the signal line 43-1A to the memory 22-1A and the memory 22-1A holds the current value therein (S23). Thereafter, the current detector 21A detects current value repeatedly at every predetermined fixed time T (S24).

The memory 22-1A holds a current value and outputs the same through a signal line 44A to the arithmetic circuit 23A every time when a new current value is sent from the current detector 21A. Moreover, the memory 22-1A outputs the current value held therein before to the memory 22-2A through a signal line 43-2A when the new current value is sent from the current detector 21A. The memory 22-2A holds the current value sent from the memory 22-1A and outputs the same through a signal line 45A to the arithmetic circuit 23A every time when the current value is sent from the memory 22-1A. Specifically, the current value held in the memory 22-1A is the newest (present) current value, and the current value held in the memory 22-2A is a current value of time T before. Note that, in order to prevent undefined operations immediately after the activation of the current detector 21A, proper values should be held in the memories 22-la and 22-2A as initial values.

The arithmetic circuit 23A obtains a differential value between the present current value sent from the memory 22-1A and the current value of time T before sent from the memory 22-2A, and outputs the obtained differential value through a signal line 46A to the alarm circuit 24A.

A threshold value Δ is previously set in the alarm circuit 24A. The alarm circuit 24A compares the differential value transmitted from the arithmetic circuit with the threshold value Δ. When the differential value exceeds the threshold value Δ, the alarm circuit 24A sends out alarm signals indicating a necessity of preventive maintenance for the optical module 10 to the computer through the signal line 47.

Next, an operation of this second embodiment will be described. As described in the first embodiment with reference to FIG. 2, when the abnormality is caused in the part constituting the optical module 10, the consumption current of the optical module 10 tends to be increased. Accordingly, in this second embodiment, a certain value Δ is set as an increment of the consumption current of the optical module for the fixed time T, and this value Δ is used as a condition for determining the time when an alarm indicating the necessity of the preventive maintenance should be given. The value Δ is previously set as a threshold value in the alarm circuit 24A. Here, it is preferable that the fixed time T be set as a relatively long time of 1 day or longer in general.

As described above, at the start time of the actual use of the optical module 10, the current detector 21A is activated by the computer (not shown) through the signal line 42. Then, the current detector 21A detects the current supplied to the optical module 10 through the power line 30 at every fixed time T. The present (newest) current value is held in the memory 22-1A, and the current value of time T before is held in the memory 22-2A, respectively. The arithmetic circuit 23A obtains the differential value between the present current value and the current value of time T before. The alarm circuit 24A compares the differential value obtained in the arithmetic circuit 23A with the threshold value Δ, and outputs the alarm signals through the signal line 47 to the computer when the differential value exceeds the threshold value Δ. Upon receiving the alarm signals through the signal line 47, the computer displays, for example, a message to request the replacement of the optical module 10 on the display device or the like. Thus, the preventive maintenance for the optical module 10 can be performed with enough time.

Next, each constituent component of the abnormality detector 20A will be described.

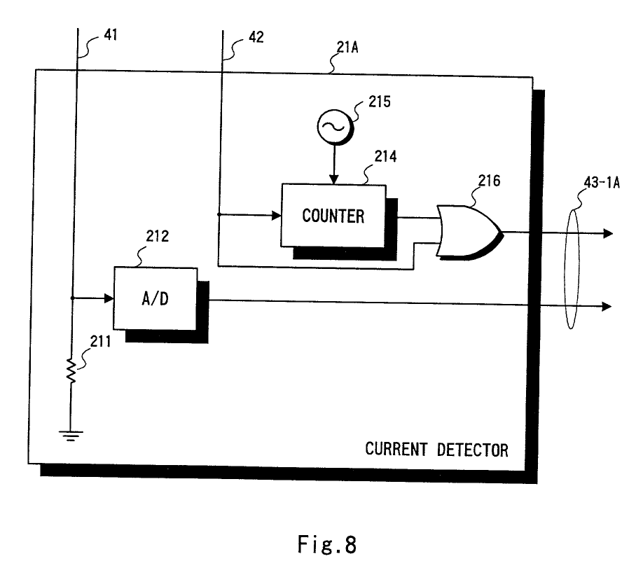

FIG. 8 shows a constitution of the current detector 21A. In the current detector 21A, a voltage proportional to the current value of the power line 30 is taken out by the resistor 211 connected with the signal line 41. A value of the voltage is digitized by the A/D converter 212 and is outputted to the memory 22-1A through the signal line 43-1A. Activation signal from the computer (not shown) through the signal line 42 is outputted through an OR circuit 216 and the signal line 43-1A to the memory 22-1A as writing signal thereto, and is used as activation signal for the counter 214. Upon receiving the activation signal, the counter 214 starts to count output pulses of the oscillator 215. When a count value reaches a value equivalent to the time T, the counter 214 outputs the writing signal through the OR circuit 216 and the signal line 43-1A to the memory 22-1A, and resets the count value to start the count again. Accordingly, when the activation signal is inputted through the signal line 42 to the current detector 21A, a current value of the power line 30 at this time is written into the memory 22-1A. Thereafter, every time when the fixed time T passes, the current value of the power line 30 at each point of time is written into the memory 22-1A. In this case, the current value held in the memory 22-1A is shifted to the memory 22-2A.

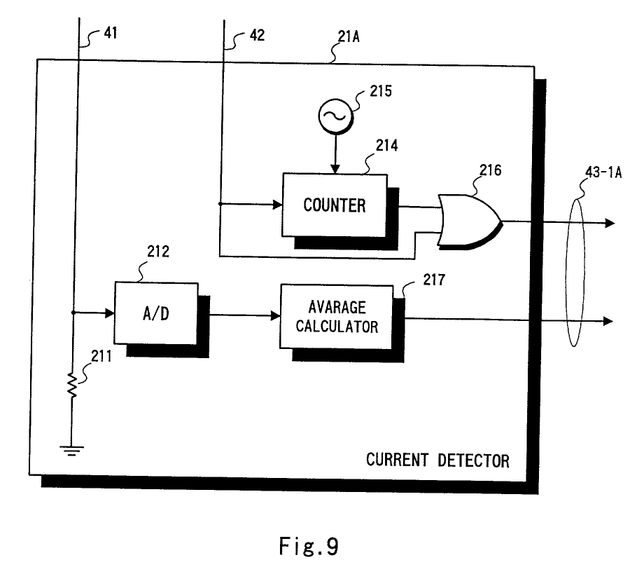

With reference to FIG. 9, another constitution example may be adopted, in which the average calculator 217 is provided just behind the A/D converter 212, and not a current value on the power line 30 in a moment but an average value of the current values for a period of several seconds may be obtained.

The memories 22-1A and 22-2A in the abnormality detector 20A can be constituted of, for example, a register. The arithmetic circuit 23A can be constituted of, for example, a subtracter that subtracts the current value sent from the memory 22-2A from the current value sent from the memory 22-1A. The alarm circuit 24A can be constituted of a comparator which compares the current value through the signal line 46A with the threshold value Δ and setting an output thereof (alarm signals) at a logic “1” if the current value exceeds the threshold value Δ.

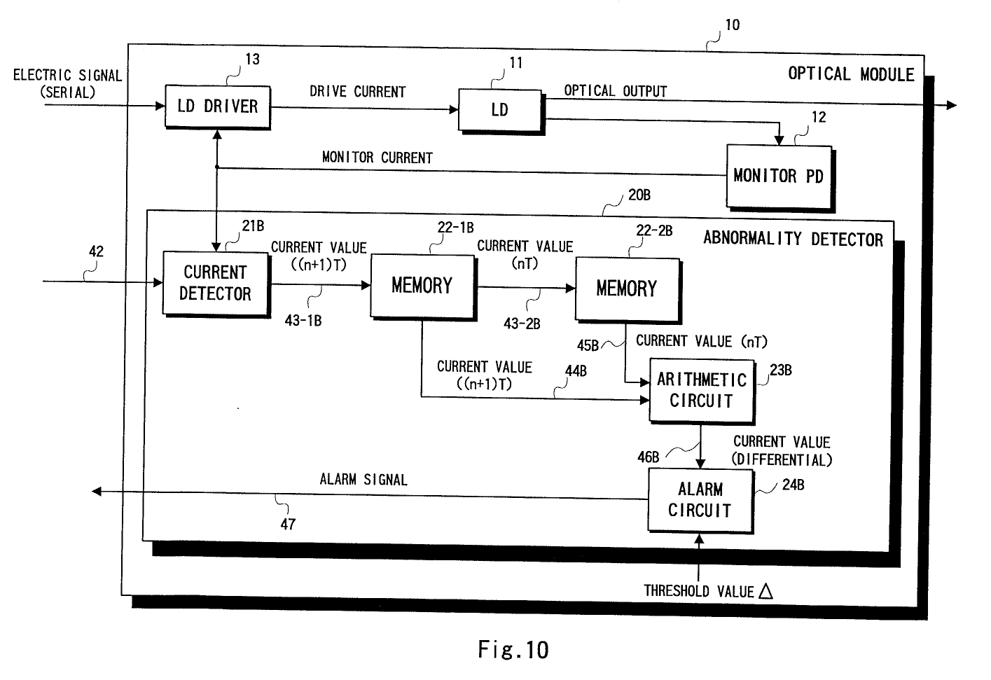

With reference to FIG. 10, a third embodiment of the present invention will be described. An abnormality detector 20B is built in the optical module 10 as an object for abnormality detection, and detects an abnormality of the optical module 10 by monitoring a monitor current of the monitor PD 12. The abnormality detector 20B includes a current detector 21B, two memories 22-1B and 22-2B, an arithmetic circuit 23B and an alarm circuit 24B. The optical module 10 as an object for abnormality detection has the same constitution as that described with reference to FIG. 12 except that the abnormality detector 20B is built therein. FIG. 10 shows only a transmission system thereof.

The current detector 21B receives a monitor current outputted from the monitor PD 12, and is connected with a computer (not shown) through the signal line 42 and with the memory 22-1B through a signal line 43-1B, respectively. Receiving activation signals from the computer (not shown) through the signal line 42, the current detector 21B is activated. The current detector 21B first detects a monitor current value of the monitor PD 12. The current detector 21B sends the detected current value through the signal line 43-1B to the memory 22-1B to be held therein. Thereafter, the current detector 21B detects a current value repeatedly at every predetermined fixed time T and sending the detected current value through the signal line 43-1B to the memory 22-1B to be held therein. This operation of the current detector 21B is the same as the operation of the current detector 21A of the second embodiment described with reference to FIG. 7.

The memory 22-1B holds a current value and outputs the same through a signal line 44B to the arithmetic circuit 23B every time when the monitor current value is sent from the current detector 21B. Moreover, the memory 22-1B outputs the monitor current value held therein before to the memory 22-2B, when a new monitor current value is sent from the current detector 21B. The memory 22-2B holds the monitor current value and outputs the same through a signal line 45B to the arithmetic circuit 23B every time when the monitor current value is sent from the memory 22-1B. Specifically, the monitor current value held in the memory 22-1B is the newest (present) current value, and the monitor current value held in the memory 22-2B is a current value of time T before. Note that, in order to prevent undefined operations immediately after the activation of the current detector 21B and in the period of time when the current value is detected twice, proper values should be held in the memories 22-1B and 22-2B as initial values.

The arithmetic circuit 23B obtains a differential value between the monitor current value of time T before transmitted from the memory 22-2B and the present monitor current value transmitted from the memory 22-1B, and outputs the obtained differential value through a signal line 46B to an alarm circuit 24B.

A threshold value Δ is previously set in the alarm circuit 24B. The alarm circuit 24B compares the differential value transmitted from the arithmetic circuit 23B with the threshold value Δ. When the differential value exceeds the threshold value Δ, the alarm circuit 24B sends out alarm signal indicating a necessity of preventive maintenance for the optical module 10 to the computer through the signal line 47.

Each constituent component of the abnormality detector 20B can be realized similarly to the abnormality detector 20A in the second embodiment.

Next, an operation of the third embodiment will be described. In the optical module 10 having the APC function, lowering of the optical output due to deterioration of the LD 11 is compensated by increasing the bias current. However, as the LD 11 is further deteriorated, the lowering of the optical output cannot be sufficiently compensated by increasing the bias current, thus tending to lower the optical output. Accordingly, as the LD11 is deteriorated, the monitor current of the monitor PD12 is lowered. In this embodiment, a certain value Δ is set as a reduction from the consumption current of the optical module in the fixed time T, and this value Δ is used as a condition for determining the time when an alarm indicating the necessity of the preventive maintenance should be given. The value Δ is previously set as a threshold value in the alarm circuit 24. Here, it is preferable that the fixed time T be set as a relatively long time of 1 day or longer in general.

When the current detector 21B is activated at the start time of the use of the optical module 10, the current detector 21B detects the monitor current of the monitor PD 12 at every fixed time T. The present (newest) monitor current value is held in the memory 22-1B, and the monitor current value of time T before is held in the memory 22-2B, respectively. The arithmetic circuit 23B obtains the differential value between the present current value and the current value of time T before. The alarm circuit 24B compares the differential value with the preset threshold value Δ, and outputs the alarm signal through the signal line 47 to the computer (not shown) when the differential value exceeds the threshold value Δ. Receiving the alarm signal through the signal line 47, the computer displays, for example, a message to request the replacement of the optical module 10 on the display device or the like. Thus, the preventive maintenance for the optical module 10 can be performed with enough time.

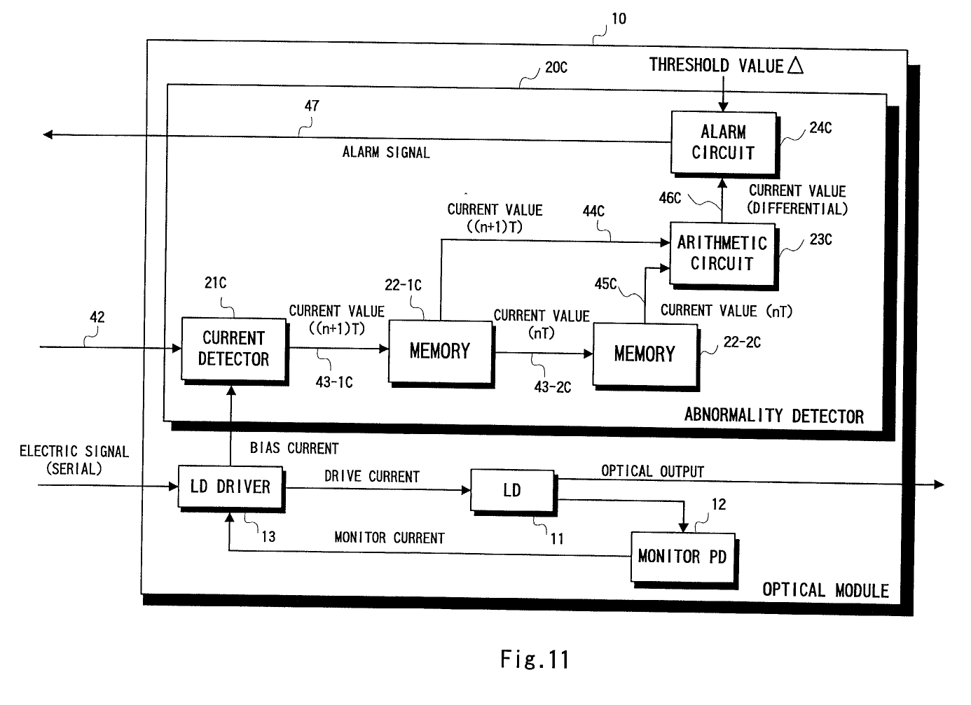

With reference to FIG. 11, an abnormality detector 20C according to a fourth embodiment of the present invention is built in the optical module 10 as an object for abnormality detection similarly to that of the third embodiment. The abnormality detector 20C detects an abnormality of the optical module 10 by monitoring a bias current applied to the LD11 in the optical module 10. The abnormality detector 20C includes a current detector 21C, two memories 22-1C and 22-2C, an arithmetic circuit 23C and an alarm circuit 24C. The optical module 10 as an object for abnormality detection has the same constitution as that described with reference to FIG. 12 except that the abnormality detector 20C. FIG. 11 shows only a transmission system thereof.

The current detector 21C receives a bias current applied to the LD 11 from the LD driver 13, and is connected with a computer (not shown) through the signal line 42 and with the memory 22-1C through a signal line 43-1C, respectively. Upon receiving activation signals from the computer through the signal line 42, the current detector 21C is activated. The current detector 21C first detects a bias current value of the LD 11. Then, the current detector 21C sends the detected current value through the signal line 43-1C to the memory 22-1C to be held therein. Thereafter, the current detector 21C detects a bias current value of the LD 11 at every predetermined fixed time T and sending the detected current value through the signal line 43-1C to the memory 22-1C to be held therein.

The memory 22-1C holds a bias current value and outputs the same through a signal line 44C to the arithmetic circuit 23C every time when the bias current value is sent from the current detector 21C. Moreover, the memory 22-1C outputs the bias current value held therein before to the memory 22-2C when a new bias current value is sent from the current detector 21C. The memory 22-2C holds the bias current value and outputs the same through a signal line 45C to the arithmetic circuit 23C every time when the bias current value is sent from the memory 22-1C. Specifically, the bias current value held in the memory 22-1C is the newest (present) bias current value, and the bias current value held in the memory 22-2C is a current value of time T before. Note that, in order to prevent the undefined operations immediately after the activation and in the period of time when the bias current value is detected twice, proper values should be held in the memories 22-1C and 22-2C as initial values.

The arithmetic circuit 23C obtains a differential value between the present bias current value transmitted from the memory 22-1C and the bias current value of time T before transmitted from the memory 22-2C, and outputs the obtained differential value through a signal line 46C to an alarm circuit 24C.

A threshold value Δ is previously set in the alarm circuit 24C. The alarm circuit 24C compares the differential value transmitted through the signal line 46C with the threshold value Δ. When the differential value exceeds the threshold value Δ, the alarm circuit 24C sends out alarm signal to the computer (not shown) through the signal line 47.

Each constituent component of the abnormality detector 20C can be realized similarly to the abnormality detector 20A in the second embodiment.

Next, an operation of the fourth embodiment will be described. A value Δ as a condition for generating the alarm signals is previously determined and set as a threshold value in the alarm circuit 24C. Here, it is preferable that the fixed time T be set as a relatively long time of 1 day or longer in general.

At the start time of the actual use of the optical module 10, the current detector 21C is activated by the computer (not shown) through the signal line 42. The current detector 21C detects the bias current value of the LD 11 at every fixed time T, and sends the present (newest) bias current value to the memory 22-1C to be held therein and the bias current value of time T before to the memory 22-2C to be held therein, respectively. The arithmetic circuit 23C obtains the differential value between the present bias current value and the bias current value of time T before. The alarm circuit 24C outputs the alarm signals through the signal line 47 to the computer (not shown) when the differential value exceeds the threshold value Δ. Upon receiving the alarm signals, the computer (not shown) displays, for example, a message to request the replacement of the optical module 10 on the display device or the like.

Although the present invention has been described above with reference to some embodiments, the present invention is not limited to the above embodiments, and further includes an embodiment as below.

The abnormality detector 20B shown in FIG. 10 and the abnormality detector 20C shown in FIG. 11 may be constituted in such a manner that the initial current value is used as a reference for comparison similarly to the abnormality detector 20 shown in FIG. 1. Specifically, the current detector 21 detects a monitor current value of the monitor PD 12 in the initial state of the optical module 10, and allows the detected monitor current value to be held in the memory 22. Thereafter, the current detector 21 detects a monitor current value at every fixed time, and the arithmetic circuit 23 obtains a differential value between the detected monitor current value and the initial current value held in the memory 22. The alarm circuit 24 generates alarm signal when the differential value exceeds a predetermined threshold value.

In each embodiment described above, the alarm circuit 24 compares the differential value with the threshold value. However, the alarm circuit 24 may compare a ratio of the differential value to the past current value with the threshold value. For example, in the first embodiment shown in FIG. 1, after obtaining the differential value between the present current value and the initial current value, the arithmetic circuit 23 obtains a ratio of the differential value to the initial current value, and outputs the same to the alarm circuit 24. The alarm circuit 24 compares the ratio of the differential value to the initial current value with the preset threshold value, and generates alarm signal when the obtained ratio exceeds the threshold value. Moreover, in the second embodiment shown in FIG. 6, after obtaining the differential value between the present current value and the current value of time T before, the arithmetic circuit 23A obtains a ratio of the differential value to the current value of time T before and outputs the same to the alarm circuit 24A. The alarm circuit 24A compares the ratio sent from the arithmetic circuit 23A with the preset threshold value, and generates the alarm signal when the ratio exceeds the threshold value. The same can be applied to other embodiments.

The SFF (Small Form Factor) module described with reference to FIG. 12 is exemplified as the optical module in each of the above embodiments. However, the present invention is not limited to this, and any optical module such as a Gigabit Link Module (GLM), a GigaBit Interface Converter (GBIC) and a 1×9 module is applicable to an object for abnormality detection of the present invention. Moreover, a communication speed of 1.0625 Gbps compliant with Fiber Channel is exemplified as that of the optical module. However, it is a matter of course that the present invention is applicable to an optical module having any other communication speeds. Furthermore, the present invention is also applicable to an optical module using a light emitting diode (LED) as a transmission light source.

A specific example will be described below. When a specified value Δ is set at 20 mA, if a bias current value of a certain LD(a) in a normal state is 230 mA, 250 mA is set as a threshold value for detecting an abnormality of the LD (a). Moreover, when a bias current value of another LD(b) in the normal state is 235 mA, 255 mA is set as a threshold value for detecting an abnormality of the LD (b). Thus, alarms are given when the bias current value of the LD(a) exceeds 250 mA and when the bias current value of the LD(b) exceeds 255 mA.

On the contrary, in the present invention, a specified value Δ (20 mA) is set as threshold value for both of the LD(a) and LD(b). In the optical module including the LD(a) and the optical module including the LD(b), the bias current values at the beginning of the use of the optical modules are detected to be held in the memory. If the bias current value at the beginning of the use in the LD(a) is 230 mA, and the bias current value in the LD(b) is 235 mA, the values are held in the memory. When the bias current value in the LD(a) exceeds 250 mA, the differential value is larger than 20 mA (=250 mA-230 mA), that is, the differential value exceeds the threshold value Δ (=20 mA), and thus the alarm is given. Moreover, in the optical module including the LD(b), when the bias current value in the LD(b) exceeds 255 mA, the differential value is larger than 20 mA (=255 mA-235 mA), that is, the differential value exceeds the threshold value Δ (=20 mA), and thus the alarm is given. In this way, since the present invention uses the threshold value and the differential value between two current values for detecting the abnormality, there is no need to measure the bias current values of each module in the normal state beforehand nor to set the threshold values for each module.

When the bias current of the LD in the optical module is increased, the consumption current of the entire optical module is increased. Thus, even when a current value of the power line for supplying power to the optical module is set as an object to be monitored, a similar effect is obtained (further effect will be described later). Moreover, when the LD is deteriorated over time, the lowering of the optical output resulting from the deterioration cannot be prevented even by the APC function, and the monitor current is gradually reduced. Therefore, the same effect is obtained even when the monitor current is set as an object to be monitored.

Furthermore, the same effect is obtained even when the current value of a specified time before is used as the past value from the present. For example, if the current value of time T before is used as the past value, the threshold value is previously determined in response to the amount of the change in the current value during the time T, which is a condition for determining the time when an alarm should be given. Here, it is preferable that the fixed time T be set as a relatively long time of 1 day or longer in general. For example, if T is set at 100 hours and the threshold value is set at 5 mA, when the differential value between the monitored present current value and the current value of 100 hours before exceeds 5 mA, the alarm is given.

Furthermore, the same effect is obtained even in the constitution, in which the ratio of the differential value between the past value and the present value to the past value is compared with the threshold value. For example, consideration will be made for a constitution, in which the bias current value of the LD is set as a current value to be monitored similarly to the prior art, and the bias current value of the LD at the beginning of the use of the optical module is set as a past current value. Here, the past current value of the LD(a) is set at 230 mA, the past current value of the LD(b) is set at 235 mA in the beginning of the use, and the threshold value is set at, for example, 8%. In this case, in the optical module including the LD (a), when the bias current value of the LD (a) exceeds the LD(a) exceeds about 249 mA, the ratio of the differential value to the past current value is about 8.3% (≈(249 mA-230 mA)/230 mA), which exceeds 8% of the threshold value. Thus, the alarm is given. Moreover, in the optical module including the LD(b), when the bias current value of the LD(b) exceeds 254 mA, the ratio of the differential value to the past value is 8.1% (≈(254 mA-235 mA)/235 mA), which also exceeds 8% of the threshold value. Thus, the alarm is given.

As described above, according to the present invention, an effect as below is obtained.

The present invention simplifies setting of the threshold value for detecting the occurrence of the abnormality by which the probability of the breakdown is possibly increased. The reason is as follows. Specifically, in the abnormality detector and method of the present invention, the value of the current flowing through a specified spot of the optical module is detected. The differential value indicating a variation between the past current value and the present current value is compared with the threshold value, alternatively, the ratio of the differential value to the past current value is compared with the threshold value. Thus, the apparatus and the method of the present invention control the generation of the alarm signal. Therefore, even if an equal threshold value is set for the respective objects to be detected, variations in characteristics of the individual optical modules are absorbed.

Moreover, in the constitution for monitoring the current value of the power line for supplying power to the optical module, since the optical module itself does not have to be modified, there is an effect that a commercially available optical module can be applied thereto. Furthermore, there is obtained an effect that the abnormalities not only of the transmission light source such as an LD in the optical module but also of the other parts such as the LD driver due to deterioration over time can be detected.

What is claimed is:

1. A method for detecting an abnormality of an optical module comprising the steps of:
(a) detecting a value of a current flowing through a specified spot of the optical module;
(b) holding the detected value of the current in a memory;
(c) detecting a value of a current flowing through the specified spot at every predetermined time;
(d) obtaining a differential value between the value of the current held in the memory and the value of the current newly detected; and
(e) generating alarm signal indicating a necessity of preventive maintenance when the obtained differential value exceeds a predetermined threshold value.

2. The method for detecting an abnormality of an optical module according to claim 1,
wherein the value of the current flowing through the specified spot is a value of a current in a power line for supplying power to the optical module.

3. The method for detecting an abnormality of an optical module according to claim 1,
wherein the value of the current flowing through the specified spot is a monitor current value of an optical output of the optical module.

4. The method for detecting an abnormality of an optical module according to claim 1,
wherein the value of the current flowing through the specified spot is a value of a bias current of the transmission light source.

5. The method for detecting an abnormality of an optical module according to claim 1,
wherein the value of the current hold in the memory is a value of a current flowing through the specified spot at the start time of the use of the optical module.

6. The method for detecting an abnormality of an optical module according to claim 1,
wherein the value of the current held in the memory is overwritten to the value of the current which is newly detected in the specified spot when a differential value is obtained.

7. The method for detecting an abnormality of an optical module according to claim 1,
wherein the detected value of the current flowing through the specified spot of the optical module is an average value of currents for the predetermined time.

8. A method for detecting an abnormality of an optical module comprising the steps of:
(a) detecting a value of a current flowing through a specified s pot of the optical module;
(b) holding the detected value of the current in a memory;
(c) newly detecting a value of a current flowing through the specified spot at every predetermined time;
(d) obtaining a ratio of a differential value between the value of the current held in the memory and the value of the current newly detected to the value of the current held in the memory; and
(e) generating alarm signal indicating a necessity of preventive maintenance when the obtained ratio exceeds a predetermined threshold value.

9. An apparatus for detecting an abnormality of an optical module comprising:
a current detector which detects a value of a current flowing through a specified spot of said optical module;
a memory which holds the value of the current detected by said current detector;
an arithmetic circuit which obtains a differential value between the value of the current held in said memory and a value of a current newly detected by said current detector; and
an alarm circuit which generates alarm signal indicating a necessity of preventive maintenance when the differential value obtained by said arithmetic circuit exceeds a predetermined threshold value.

10. The apparatus for detecting an abnormality of an optical module according to claim 9,
wherein the value of the current flowing through the specified spot is a value of a current in a power line for supplying power to said optical module.

11. The apparatus for detecting an abnormality of an optical module according to claim 9,
wherein the value of the current flowing through the specified spot is a value of a current of a transmission light source.

12. The apparatus for detecting an abnormality of an optical module according to claim 9,
wherein the value of the current held in said memory is a value of a current flowing through the specified spot, the value of the current being detected by said current detector at the start time of the use of said optical module.

13. The apparatus for detecting an abnormality of an optical module according to claim 9,
wherein said current detector detects a value of a current flowing through the specified spot at every predetermined time, and sends out the detected value of the current to said memory.

14. The apparatus for detecting an abnormality of an optical module according to claim 9,
wherein said memory includes a first memory and a second memory,
said first memory receives and holds a value of a current from said current detector, and sends out the value of the current held until then to said second memory,
said second memory holds the value of the current sent from said first memory, and
said arithmetic circuit obtains a differential value between the values of the currents held in said first memory and said second memory.

15. The apparatus for detecting an abnormality of an optical module according to claim 9,
wherein said current detector detects an average value of currents flowing though the specified spot for a predetermined time as a value of a current.

16. An apparatus for detecting an abnormality of an optical module comprising:
a current detector which detects a value of a current flowing through a specified spot of said optical module;
a memory which holds the past value of the current detected by said current detector;
an arithmetic means which obtains a ratio of a differential value between said past value held in said memory and a value of a current detected at present by said current detector; and
alarming means which generates alarm signal indicating a necessity of preventive maintenance when the ratio obtained by said arithmetic means exceeds a predetermined threshold value.
